(19) United States
(12) Patent Application Publication
(10) Pub. No.: US 2010/0087164 A1
(43) Pub. Date: Apr. 8, 2010

(54) WLAN SET UP USING PHONE NUMBER IDENTIFICATION APPARATUS AND METHOD

(75) Inventors: Tobias Jan Robert RITZAU, Veberod (SE); Nils Ola MONTAN, Akarp (SE); Troed SANGBERG, Malmo (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 12/325,341

(22) Filed: Dec. 1, 2008

Related U.S. Application Data
(60) Provisional application No. 61/102,862, filed on Oct. 5, 2008.

(51) Int. Cl. H04M 1/66; H04W 4/00

(52) U.S. Cl. 455/411; 455/466

(57) ABSTRACT

WLAN set up is facilitated using phone number identification between a mobile phone that has access to the WLAN and another mobile phone or a computer that it is desired to have access to the WLAN. A visiting mobile phone is used to send a text message, e.g., SMS message, to a home mobile phone, which has permission to access the WLAN; the text message indicates a request for permission to access the WLAN. The home mobile phone may operate automatically, semi-automatically or manually to provide permission and parameters for the visiting mobile phone to access and to connect to the WLAN or to deny permission and access. A computer may dial the visiting mobile phone, which has obtained permission to access the WLAN, and may retrieve the WLAN parameters and use them to access and to connect to the WLAN.

### CROSS-REFERENCE TO RELATED APPLICATION

This application claims the benefit of U.S. Provisional Patent Application Ser. No. 61/102,862, filed Oct. 5, 2008, the entire disclosure of which is hereby incorporated by reference.

### TECHNICAL FIELD OF THE INVENTION

The technology of the present disclosure relates generally to communicating with wireless networks and, more particularly, to a system and method for obtaining permission to access and for accessing a wireless local area network via a mobile wireless electronic device.

### BACKGROUND

Mobile wireless electronic devices are becoming increasingly popular. For example, mobile telephones, portable computers, portable media players and portable gaming devices are now in wide-spread use. In addition, the features associated with certain types of electronic devices have become increasingly diverse. To name a few examples, many electronic devices have cameras, text messaging capability, Internet browsing capability, electronic mail capability, video playback capability, audio playback capability, image display capability and handsfree headset interfaces.

Mobile wireless electronic devices also have the capability and are used to access networks, such as, for example, wireless local area networks (referred to below as “WLAN”) and other networks. For example, by connecting with a WLAN the mobile wireless electronic device may connect with other devices that are connected to that WLAN and also may connect with a broader network, e.g., the Internet, another global or more limited network, etc.

In the description herein reference is made to WLAN; however, it will be appreciated that such description may apply to other networks, as will be appreciated by persons who have ordinary skill in the art.

Access to a WLAN may require permission. For example, one or more parameters, such as a key, a code, or one or more other parameters, may be needed to signify permission to access a WLAN. If those parameters are provided to the WLAN, e.g., at an access point device, for example, a router, access would be permitted and wireless connection can be made to the WLAN.

To connect a mobile wireless electronic device to a WLAN may require a number of relatively complex and/or time consuming steps and also may require certain knowledge of steps that have to be taken to obtain access to the WLAN. Obtaining the permission to make the connection may be problematic. For example, one or more of those steps may be obtaining the needed parameters, knowing how to find the parameters and where to input the parameters in the mobile wireless electronic device, entering the parameters in the device, transmitting the parameters, etc.

### SUMMARY

There is a need to facilitate obtaining permission and/or setting up communication and/or connection between a mobile wireless electronic device and a WLAN.

According to an aspect of the present invention an electronic device to connect by wireless communication with a network, includes a control circuit configured to generate a request for permission for wireless access to a network from a wireless communication device, which is permitted access to the network, a radio configured to transmit the request for permission and to receive an indication of permission for wireless accessing of the network, and wherein following receipt of the permission the control circuit configures the radio to connect wirelessly with the network.

According to another aspect the radio is configured to transmit an SMS (short message service) message to request permission.

According to another aspect, the radio is configured to receive an SMS message granting permission.

According to another aspect the radio is configured to transmit a text message or other message to request permission.

According to another aspect, the radio is configured to receive a test message or other message granting permission.

According to another aspect, the requested permission is for parameters to access a wireless local area network.

According to another aspect, the requested permission is to connect wirelessly with an access point of a local area network.

According to another aspect, the radio is configured to request permission for wireless access to a network from the wireless communication device that is configured and has permission to connect wirelessly with the network.

According to another aspect, following receipt of the permission with parameters to access a wireless local area network, the control circuit automatically configures the radio to connect with the network.

According to another aspect, the electronic device includes a display, and wherein the control circuit is configured in response to receipt of the permission to display parameters to access a wireless local area network.

According to another aspect, the electronic device includes a manually operable input device to input parameters for the radio to connect wirelessly to the network.

According to another aspect, the manual input device is at least one of keys or a touch sensitive display.

According to another aspect, the electronic device is a mobile telephone.

According to another aspect, the electronic device includes a computer.

According to another aspect, a computer includes a computer control circuit configured to operate the computer to access a browser, a computer radio configured to connect with the wireless communication device, wherein the computer control circuit is configured to operate the computer radio to communicate with the wireless communication device to retrieve parameters for accessing the network.

According to another aspect, the computer control circuit is configured to respond to the retrieved parameters to operate the computer radio to access the network.

According to another aspect, the computer further includes an input device to receive manual inputs of the parameters for accessing the network and the control circuit being configured in response to the parameters to access the network.

According to another aspect, the computer control circuit is configured to operate the computer radio automatically to use the parameters received from the wireless communication device to access the wireless local area network.

According to another aspect of the invention a computer includes a computer control circuit configured to operate the computer to access a browser to connect with a wireless communication device that has permission to access a wireless local area network to obtain from the wireless communication device parameters for accessing the wireless local area network, a computer radio configured to connect with the wireless communication device under control of the computer control circuit, wherein the computer control circuit is configured to operate the computer radio to communicate with the wireless communication device to retrieve parameters for accessing the network, and wherein the computer control circuit is configured to respond to the retrieved parameters to operate the computer radio to access the wireless local area network.

According to another aspect, the computer further includes an input device to receive manual inputs of the parameters for accessing the network and the computer control circuit being configured in response to the parameters to access the network.

According to another aspect, the computer control circuit is configured to operate the computer radio automatically to use the parameters received from the wireless communication device to access the wireless local area network.

According to another aspect of the invention, a method includes generating a request for permission for wireless access to a network from a wireless communication device, which is permitted access to the network, transmitting the request for permission and receiving an indication of permission for wireless accessing of the network, and following receipt of the permission the control circuit connecting wirelessly with the network.

According to another aspect of the invention a computer includes a control circuit, a radio, and a browser or other application that are configured and cooperative under control of the control circuit to connect with a wireless communication device that has permission to access a wireless local area network to obtain from the wireless communication device parameters for accessing the wireless local area network, and wherein after the computer receives the retrieved parameters the computer radio configured by the control circuit to access the wireless local area network.

According to another aspect of the invention a computer uses a browser or other method to connect with a wireless communication device that has permission to access a wireless local area network to obtain from the wireless communication device parameters for accessing the wireless local area network, a wireless connection is made with the wireless communication device to retrieve parameters for accessing the network, and in response to the retrieved parameters the computer radio accesses the wireless local area network.

According to an aspect of the present invention an electronic device that is capable of connecting and has permission to connect by wireless communication with a network, includes a control circuit configured to respond to a request for permission for wireless access to the network from another mobile wireless communication device, a radio configured to transmit the requested permission for wireless accessing of the network, and wherein following receipt of the request for permission the control circuit configures the radio to transmit the permission to connect wirelessly with the network.

According to another aspect a mobile wireless communication device receives a request for permission to access a WLAN, and if permission is to be granted, the mobile wireless communication device transmits the permission and suitable parameters to access the WLAN.

These and further aspects and features will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the scope of the claims appended hereto.

Features that are described and/or illustrated with respect to one embodiment may be used in the same way or in a similar way in one or more other embodiments and/or in combination with or instead of the features of the other embodiments.

### BRIEF DESCRIPTION OF THE DRAWINGS

FIGS. 1 and 2 are schematic illustrations of a system and method to provide wireless access and connection of a mobile wireless electronic device in the form of a mobile phone to a WLAN according to an embodiment of the invention;

FIG. 3 is a schematic illustration of a system and method to provide wireless access and connection of a mobile wireless electronic device in the form of a computer to a WLAN according to an embodiment of the invention;

FIG. 4 is a schematic view of a mobile telephone as an exemplary electronic device that includes a control circuit, one or more radios, etc., to carry out the functions and features described herein;

FIG. 5 is a schematic block diagram of the mobile telephone of FIG. 4;

FIG. 6 is a schematic illustration of a mobile telephone operable to communicate in a mobile communications system;

FIGS. 7 and 8 are exemplary flow charts or logic diagrams representing an exemplary method of use of the mobile wireless electronic devices of the invention to carry out the method of the present invention using, for example, one mobile telephone to request permission from another mobile telephone to access and to connect to a WLAN and, if permission is granted, to receive such permission from the another mobile telephone; and

FIG. 9 is an exemplary flow chart or logic diagram representing a method of use of a computer and mobile wireless communication device, e.g., a mobile telephone, selectively to obtain permission for the computer to access and to connect to a WLAN.

### DETAILED DESCRIPTION OF EMBODIMENTS

Embodiments will now be described with reference to the drawings, wherein like reference numerals are used to refer to like elements throughout. It will be understood that the figures are not necessarily to scale.

In the present document, embodiments are described primarily in the context of a mobile wireless electronic device in the form of a portable radio communications device, such as the illustrated mobile telephone(s). It will be appreciated, however, that the exemplary context of a mobile telephone is not the only operational environment in which aspects of the disclosed systems and methods may be used. Therefore, the techniques described in this document may be applied to any type of appropriate electronic device, examples of which include a mobile telephone, a mobile wireless electronic device, a media player, a gaming device, a computer, a pager, a communicator, an electronic organizer, a personal digital assistant (PDA), a smartphone, a portable communication apparatus, etc.

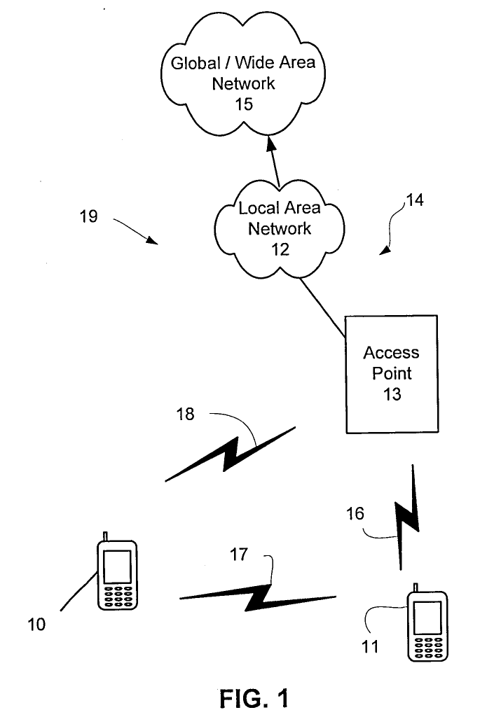

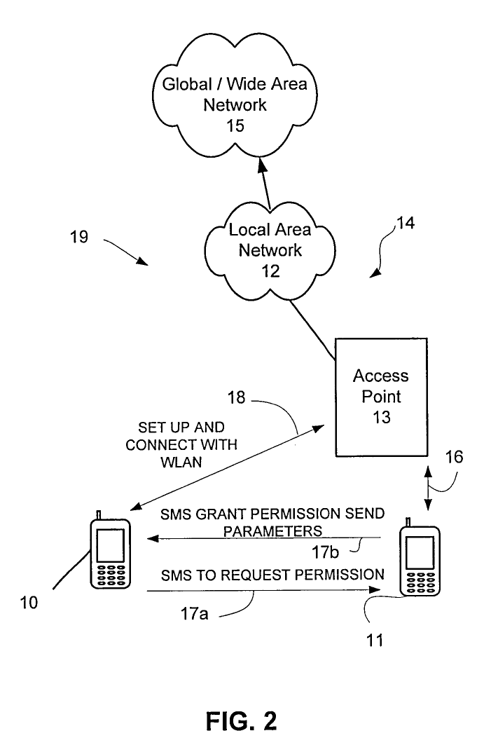

Referring initially to FIGS. 1 and 2 an embodiment of the invention is illustrated generally at 10 in the form of a mobile wireless electronic device (referred to below as “mobile phone”). The mobile phone 10 is used in conjunction with another mobile wireless electronic device 11 (also referred to below as a “mobile phone”). To distinguish between the mobile phones 10, 11, the former is referred to as a “visiting” mobile phone and the latter is referred to as a “home” mobile phone. The home mobile phone 11 is configured to access a network 12, for example, via an access point 13, such as a wireless router, server, etc. For convenience the network 12 may be referred to as a WLAN 14 or collectively the network 12 and the access point 13 may be referred to as a WLAN 14. The WLAN 14 may be connected by wired, optical or wireless connection to another network, such as, for example, the Internet (represented at 15) or some other network. By wireless communication represented by arrow 16 between the home mobile phone 11 and the WLAN 14, the home mobile phone 11 is connected with and may communicate with the WLAN 14 and via the WLAN may communicate with the network 15, etc.

It may be desired to use the visiting mobile phone 10 to connect to the WLAN 14 to communicate with the WLAN and, if desired, beyond, e.g., via the network 15. Briefly summarizing an embodiment of the present invention, such connecting of the visiting mobile phone 10 to the WLAN 14 may be carried out by sending to the home mobile phone 11 a request to connect to the WLAN 14. If that request is accepted and permission is to be granted for the visiting mobile phone to connect to the WLAN 14, then a permission is sent from the home mobile phone 11 to the visiting mobile phone 10, including parameters for the visiting mobile phone to use to connect to the WLAN. Arrow 17 in FIG. 1 and arrows 17a, 17b in FIG. 2 represent the just described communication between the visiting mobile phone 10 and the home mobile phone 11. The visiting mobile phone 10 then may send those parameters and any other needed permission information to the WLAN 14, e.g., to the access point 13, to access and, thus, to connect to the WLAN. Wireless communication between the visiting mobile phone 10 and the WLAN 14 then may be carried out, e.g., as is represented by the arrow 18.

The designations “home” and “visiting” are used to facilitate description, but they are not intended to be limiting. For example, the home mobile phone 11 may be a mobile phone that has WLAN capability and has permission to connect to the WLAN 14, e.g., already set up or “knowing” the parameters needed to access the WLAN. Reference to “access” the WLAN and “connect” to the WLAN may be used equivalently and synonymously herein. Thus, for example, the home mobile phone may be owned or ordinarily used by a person at home or at the office to access and to connect with that person's WLAN or a WLAN to which the person ordinarily connects and uses. The visiting mobile phone may be one that ordinarily is not used or had not previously been used to access the WLAN 14. For example, the visiting mobile phone may be owned by or ordinarily used by a different person than the person who ordinarily uses the home mobile phone and, therefore, may not have accessed the WLAN previously. The different person may want to access the WLAN 14 using the visiting mobile phone; and the home mobile phone may be used to grant or not to grant permission for such access. In another scenario, for example, the first mentioned person may have acquired a second mobile phone (visiting mobile phone) and may use the home mobile phone to facilitate setting up the visiting mobile phone to access the WLAN 14. These scenarios are examples, and others also may occur and utilize the invention.

As an example of the above-described operation of the visiting mobile phone 10 with the home mobile phone 11 and the WLAN 14, consider that a person desires to use a mobile phone at a friend's house to access the friend's WLAN. To provide such access, it may be a problem to get all parameters correct; and it takes time setting up the parameters to obtain access using what may be relatively limited input capabilities of the visiting mobile phone. Using the present invention such problem is solved using communication between the visiting mobile phone 10 and the home mobile phone 11, e.g., using SMS (short message service) functions, e.g., text messaging, or some other communication between those two mobile phones, etc. The phone book function of either or both the mobile phones also may be used to facilitate communication between the two mobile phones.

For example, a visitor to a friend's home may operate the visiting mobile phone 10 to select the friend (user, owner, proprietor, etc., of the home mobile phone 11) in the visiting mobile phone contacts list, phone book, etc. Alternatively the visitor may input, e.g., type in, the home mobile phone telephone number manually into the visiting mobile phone.

An application, for example, an extended phone book, etc., and/or an SMS (short message service) application may be used in the visiting mobile phone 10 to send a message, for example, an SMS message, (short message service) to the home mobile phone 11, asking for permission to access the WLAN 14. The message may be sent via a predetermined port.

Upon receiving the message, the home mobile phone 11 may display a message to indicate the visitor is asking for permission to connect to the WLAN 14. The phone number of the visiting mobile phone 10 provides to the home mobile phone 11 identification of the visiting mobile phone and that identification can be used to obtain permission for the visiting mobile phone to set up automatically access to the WLAN 14.

The received message may be displayed by the home mobile phone 11 by an application that is downloaded by the home mobile phone if it is not already available in the home mobile phone.

If access to the WLAN is allowed, the application in the home mobile phone 11, for example, sends an indication of the permission, such as the parameters for accessing the WLAN 14, back to the visiting mobile phone 10. The parameters may have to be entered into the home mobile phone 10 manually, e.g., by a user of that mobile phone. However, if the home mobile phone 11 is a WLAN type phone, e.g., it is able to connect to the WLAN 14, then the parameters may be retrieved from the WLAN configuration of the home mobile phone.

An application in the visiting mobile phone 10, e.g., the SMS application or other application that initially transmitted a message to request permission of the home mobile phone 11, may receive the message from the home mobile phone that includes the permission and parameters to connect to the WLAN 14. The visiting mobile phone may include an application to receive the parameters and to configure the home mobile phone to connect with the WLAN 14, e.g., via the access point 13, directly or by some other device.

As is described further below, the mobile phones 10, 11 may include a control circuit, one or more radios, antenna(s), etc., to carry out the various functions that are described above. Such functions and configurations described herein may be carried out by such circuitry, radio(s), etc., under control and operation of appropriate computer software, logic, etc. Examples of such logic and methods are described further below with reference to the drawings. Thus, for example, the visiting mobile phone 10 may include software and/or logic to determine operation of the control circuit, radio(s) etc., to send a request for permission, to receive permission and parameters, to implement the parameters, and to connect with the WLAN 14. Similarly, the home mobile phone 11 may include software and/or logic to receive a request for permission, to determine whether permission is to be granted, and, if granted, to transmit to the visiting mobile phone the permission, parameters, etc. The mobile phones 10, 11 may have the same or similar capabilities such that both of them may be used as a visiting mobile phone or as a home mobile phone, depending on the environment, e.g., whether visiting or at home.

Upon completing the configuration of the visiting mobile phone 10, such mobile phone is granted permission to access and may access the WLAN 14 to connect therewith and to carry out communications, etc., with respect thereto.

If desired, in an embodiment of the invention, categories of “friends” or levels of permissions persons may be established in one or both phone books or contact lists, etc. For example, if the home phone 11 identified as a friend a given visiting mobile phone (e.g., the person who typically uses a given visiting mobile phone), the home mobile phone may automatically provide permission and/or suitable parameters to allow access to that given visiting mobile phone. Thus, in response to receiving a message requesting permission to access the WLAN 14 from that visiting mobile phone 10, the home mobile phone 11 may automatically provide to that visiting mobile phone permission and the needed parameters to access the WLAN. If desired, there may be several different levels of “friend;” one level may be permitted full access to the WLAN, whereas a different level may be permitted only limited access to the WLAN, etc. Identifying contacts or persons as “friends” may be referred to in the art as “approved listing” of those individuals or those visiting mobile phones so as to provide for automatic granting of the indicated permission for access to the WLAN. The “approved list” of friends or contacts may be manually entered in the home mobile phone, for example, or contacts already in the phone book of the home mobile phone may be designated at any given time as a member of the “approved list.”

Similarly, in an embodiment there may be a disapproved list provided the home mobile phone 11 to identify requests for permission to access the WLAN 14 that are to be ignored by the home mobile phone. Such persons or such specific visiting mobile phones, e.g., as identified by their telephone number or by some other means, may be automatically denied access to the WLAN 14 by simply ignoring requests for permission received from such disapproved visiting mobile phones. If desired, an indication of such denial may be sent as a message, e.g., SMS, or otherwise communicated by the home mobile phone to the visiting mobile phone.

As still another embodiment of the invention requests from visiting mobile phones or other electronic devices may be ignored if the requester is not identified by name, telephone number or some other means in the phone book or contacts list of the home mobile phone 11.

As still another embodiment of the invention the SMS messages requesting and providing permission to access the WLAN 14 may be replaced by any trusted communication.

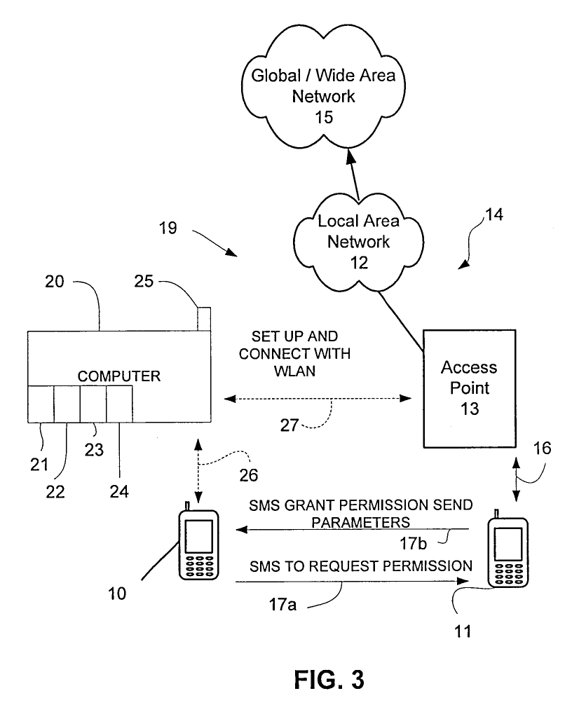

As is described by way of example herein, a communication and network system 19 includes one or more mobile phones, e.g., mobile phones 10, 11, and the WLAN 14. The system 19 also may include a computer 20, which is described below with respect to FIG. 3. The communication and network system 19 may be used to communicate voice, data, video, or any other signals, information, etc. as is currently known or may come into existence in the future.

Turning to FIG. 3, another embodiment is illustrated. In this embodiment it is may be desired for a computer 20, e.g., a mobile wireless electronic device, to obtain permission to access and to connect to the WLAN 14. The computer 20 includes a control circuit 21, e.g., a processor 21, associated memory 22 with suitable operating system, application programs, etc., display and other input/output devices 23, e.g., keyboard, display, mouse, touch-sensitive display screen, etc., and a radio 24 and antenna 25 to connect with a WLAN or the like. Operation is similar to the above-described operation using the visiting mobile phone 10 and the home mobile phone 11 such that the visiting mobile phone 10 is granted permission to access and to connect to the WLAN 14. The computer 20 then is operated to go to a specific URL or the like in a web browser application of the computer, and the telephone number of the visiting mobile phone 10 is provided at the URL. The web browser then connects to the visiting mobile phone 10, e.g., as is represented by the arrow 26, and retrieves the WLAN 14 parameters. Those parameters then may be entered manually at the keyboard, touch panel, or some other device associated with the computer 20 to identify the various network settings on the computer. The computer 20 then may access and connect to the WLAN 14, e.g., as is represented by the arrow 27. Entering of the parameters to the computer 20 also may be performed automatically by the computer 20 if the computer operating system and/or an application of the computer are capable of doing so.

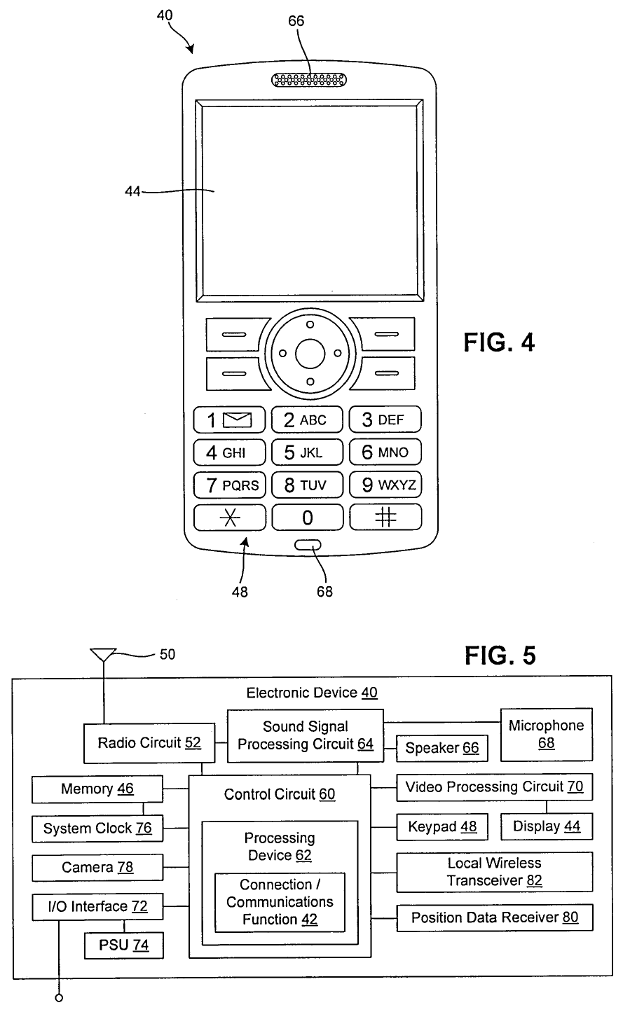

Referring to FIGS. 4 and 5, an electronic device 40 is shown. The electronic device 40 may be representative of the visiting and home mobile phones 10, 11 described above. The electronic device 40, includes a wireless connection and communication function and a messaging function, e.g., SMS, collectively shown at 42 that is configured to access a WLAN, carry out wireless communication with or via the WLAN and to carry out messaging, e.g., SMS, and/or other communication functions with a WLAN, with another mobile wireless electronic device, e.g., a mobile phone, etc. Additional details and operation of the connection and communication function 42 (which may be referred to collectively below as “communication function” for brevity) will be described in greater detail below. The communication function 42 may be embodied as executable code that is resident in and executed by the electronic device 40. In one embodiment, the communication function 42 may be one or more programs that are stored on a computer or machine readable medium. The communication function 42 may be a stand-alone software application or form a part of a software application that carries out additional tasks related to the electronic device 40.

Also, through the following description, exemplary techniques for connecting, communicating, obtaining permission, etc., as are mentioned above, for example, are described further below. It will be appreciated that through the description of the exemplary techniques, a description of steps that may be carried out in part by executing software is described. The described steps are the foundation from which a programmer of ordinary skill in the art may write code to implement the described functionality. As such, a computer program listing is omitted for the sake of brevity. However, the described steps may be considered a logical routine that the corresponding device is configured to carry out. Also, while the communication function 42 is implemented partly in software in accordance with an embodiment, such functionality could also be carried out via dedicated hardware or firmware, or some combination of hardware, firmware and/or software.

The electronic device of the illustrated embodiment is a mobile telephone, e.g., mobile phones 10, 11, and will be referred to as the electronic device 40. The electronic device 40 may include a display 44. The display 44 displays information to a user such as operating state, time, telephone numbers, contact information, various menus, etc., that enable the user to utilize the various features of the electronic device 40. The display 44 also may be used to visually display content received by the electronic device 40 and/or retrieved from a memory 46 (FIG. 5) of the electronic device 40. The display 44 may be used to present images, video and other graphics to the user, such as photographs, mobile television content, Internet pages, and video associated with games.

A keypad 48 provides for a variety of user input operations. For example, the keypad 48 may include alphanumeric keys for allowing entry of alphanumeric information (e.g., telephone numbers, phone lists, contact information, notes, text, etc.), special function keys (e.g., a call send and answer key, multimedia playback control keys, a camera shutter button, etc.), navigation and select keys or a pointing device, and so forth. Keys or key-like functionality also may be embodied as a touch screen associated with the display 44. Also, the display 44 and keypad 48 may be used in conjunction with one another to implement soft key functionality.

The electronic device 40 includes communications circuitry that enables the electronic device 40 to establish a communications with another device. Communications may include calls, data transfers, and the like. Communications also may include wireless communications with a WLAN, e.g., WLAN 14, or other network, etc. Calls may take any suitable form such as, but not limited to, voice calls and video calls. The calls may be carried out over a cellular circuit-switched network or may be in the form of a voice over Internet Protocol (VoIP) call that is established over a packet-switched capability of a cellular network or over an alternative packet-switched network (e.g., a network compatible with IEEE 802.11, which is commonly referred to as WiFia or a network compatible with IEEE 802.16, which is commonly referred to as WiMAX), for example. Data transfers may include, but are not limited to, receiving streaming content (e.g., streaming audio, streaming video, etc.), receiving data feeds (e.g., pushed data, podcasts, really simple syndication (RSS) data feeds data feeds), downloading and/or uploading data (e.g., image files, video files, audio files, ring tones, Internet content, etc.), receiving or sending messages (e.g., text messages, instant messages, electronic mail messages, multimedia messages), and so forth. This data may be processed by the electronic device 40, including storing the data in the memory 46, executing applications to allow user interaction with the data, displaying video and/or image content associated with the data, outputting audio sounds associated with the data, and so forth.

In the exemplary embodiment, the communications circuitry may include an antenna 50 coupled to a radio circuit 52. The radio circuit 52 includes a radio frequency transmitter and receiver for transmitting and receiving signals via the antenna 50.

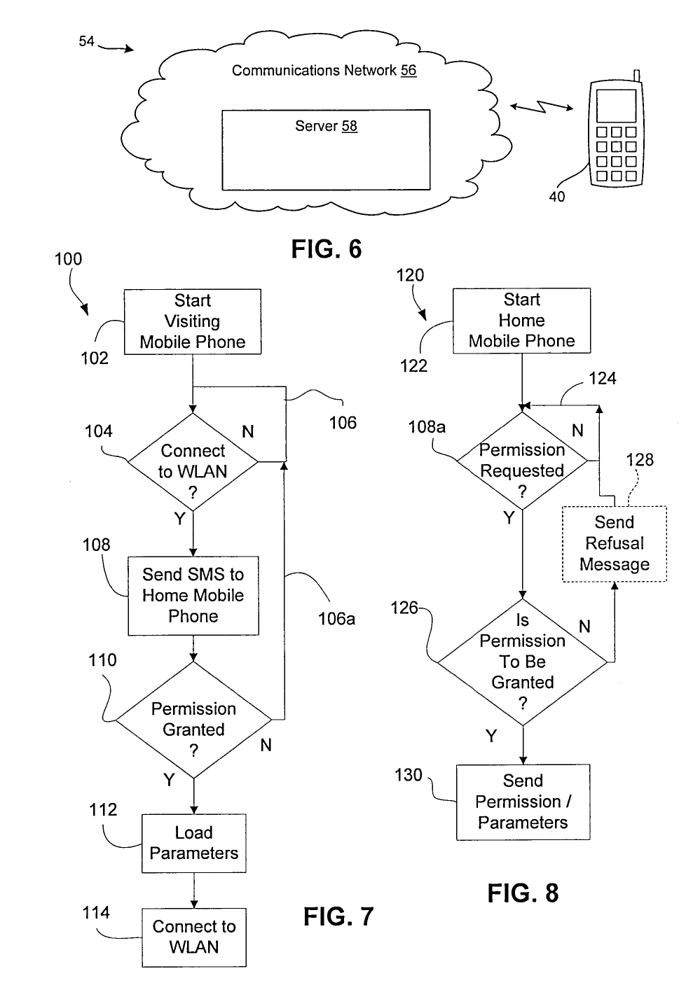

With additional reference to FIG. 6, the radio circuit 52 may be configured to operate in a mobile communications system 54 in addition to operating to communicate with a WLAN, e.g., WLAN 14. Radio circuit 52 types for interaction with a mobile radio network and/or broadcasting network include, but are not limited to, global system for mobile communications (GSM), code division multiple access (CDMA), wideband CDMA (WCDMA), general packet radio service (GPRS), WiFi, WiMAX, digital video broadcasting-handheld (DVB-H), integrated services digital broadcasting (ISDB), high speed packet access (HSPA), etc., as well as advanced versions of these standards or any other appropriate standard. It will be appreciated that the electronic device 40 may be capable of communicating using more than one standard. Therefore, the antenna 50 and the radio circuit 52 may represent one or more than one radio transceiver.

The mobile communications system 54 may include a communications network 56 having a server 58 (or servers) for managing calls placed by and destined to the electronic device 40, transmitting data to and receiving data from the electronic device 40 and carrying out any other support functions. The server 58 communicates with the electronic device 40 via a transmission medium. The transmission medium may be any appropriate device or assembly, including, for example, a communications base station (e.g., a cellular service tower, or “cell” tower), a wireless access point, a satellite, etc. The communications network 56 may support the communications activity of multiple electronic devices 40 and other types of end user devices. As will be appreciated, the server 58 may be configured as a typical computer system used to carry out server functions and may include a processor configured to execute software containing logical instructions that embody the functions of the server 58 and a memory to store such software. In alternative arrangements, the electronic device 40 may wirelessly communicate directly with another electronic device 40 (e.g., another mobile telephone or a computer) and without an intervening network. Examples of the alternative arrangements include communication between the visiting mobile phone 10 and the home mobile phone 11 (FIGS. 1, 2 and 3), between the visiting mobile phone 10 and the computer 20 (FIG. 3), etc.

The electronic device 40 may include a primary control circuit 60 that is configured to carry out overall control of the functions and operations of the electronic device 40. The control circuit 60 may include a processing device 62, such as a central processing unit (CPU), microcontroller or microprocessor. The processing device 62 executes code stored in a memory (not shown) within the control circuit 60 and/or in a separate memory, such as the memory 46, in order to carry out operation of the electronic device 40. For instance, the processing device 62 may execute code that implements the wireless connection and communication function 42, including, for example, SMS or other message function to request permission, to give permission, to transmit, receive and/or enter parameters to access a WLAN, e.g., WLAN 14, etc. The memory 46 may be, for example, one or more of a buffer, a flash memory, a hard drive, a removable media, a volatile memory, a non-volatile memory, a random access memory (RAM), or other suitable device. In a typical arrangement, the memory 46 may include a non-volatile memory for long term data storage and a volatile memory that functions as system memory for the control circuit 60. The memory 46 may exchange data with the control circuit 60 over a data bus. Accompanying control lines and an address bus between the memory 46 and the control circuit 60 also may be present.

The electronic device 40 further includes a sound signal processing circuit 64 for processing audio signals transmitted by and received from the radio circuit 52. Coupled to the sound processing circuit 64 are a speaker 66 and a microphone 68 that enable a user to listen and speak via the electronic device 40. The radio circuit 52 and sound processing circuit 64 are each coupled to the control circuit 60 so as to carry out overall operation. Audio data may be passed from the control circuit 60 to the sound signal processing circuit 64 for playback to the user. The audio data may include, for example, audio data from an audio file stored by the memory 46 and retrieved by the control circuit 60, or received audio data such as in the form of voice communications or streaming audio data from a mobile radio service. The sound signal processing circuit 64 may include any appropriate buffers, decoders, amplifiers and so forth.

The display 44 may be coupled to the control circuit 60 by a video processing circuit 70 that converts video data to a video signal used to drive the display 44. The video processing circuit 70 may include any appropriate buffers, decoders, video data processors and so forth. The video data may be generated by the control circuit 60, retrieved from a video file that is stored in the memory 46, derived from an incoming video data stream that is received by the radio circuit 52 or obtained by any other suitable method. Alternatively, instead of or in addition to a video processing circuitry 70 to operate the display 44, another display driver may be used.

The electronic device 40 may further include one or more input/output (I/O) interface(s) 72. The I/O interface(s) 72 may be in the form of typical mobile telephone I/O interfaces and may include one or more electrical connectors. The I/O interfaces 72 may form one or more data ports for connecting the electronic device 40 to another device (e.g., a computer) or an accessory (e.g., a personal handsfree (PHF) device) via a cable. Further, operating power may be received over the I/O interface(s) 72 and power to charge a battery of a power supply unit (PSU) 74 within the electronic device 40 may be received over the I/O interface(s) 72. The PSU 74 may supply power to operate the electronic device 40 in the absence of an external power source. The I/O interface 72 may be coupled to receive data input and/or commands from by the keypad 48, from a touch sensitive display 44 and to show/display information via the display 44.

The electronic device 40 also may include various other components. For instance, a system clock 76 may clock components such as the control circuit 60 and the memory 46. A camera 78 may be present for taking digital pictures and/or movies. Image and/or video files corresponding to the pictures and/or movies may be stored in the memory 46. A position data receiver 80, such as a global positioning system (GPS) receiver, Galileo satellite system receiver or the like, may be involved in determining the location of the electronic device 40. A local wireless interface 82, such as an infrared transceiver and/or an RF transceiver (e.g., a Bluetooth chipset) may be used to establish communication with a nearby device, such as an accessory (e.g., a PHF device), another mobile radio terminal, a computer or another device and/or with the WLAN 14.

It will be appreciated that the processing device 62 may execute code that implements the connection and communications function 42. It will be apparent to a person having ordinary skill in the art of computer programming, and specifically in application programming for mobile telephones or other electronic devices, how to program a electronic device 40 to operate and carry out logical functions associated with the connection and communications function 42. Accordingly, details as to specific programming code have been left out for the sake of brevity. Also, while the connection and communications function 42 is executed by the processing device 62 in accordance with an embodiment, such functionality could also be carried out via dedicated hardware or firmware, or some combination of hardware, firmware and/or software.

Examples of computer program flow charts or logic diagrams for carrying out the various functions described above, e.g., connection and communications function 42, for example to provide for wireless access and connection to a WLAN, e.g., WLAN 14, are described below. The other typical telephone, SMS and other functions of the respective mobile phones 10, 11 and computer functions of the computer 20 may be carried out in conventional manner and in the interest of brevity are not described in detail herein; such typical functions and operations will be evident to persons who have ordinary skill in the art of mobile phones, computers and other electronic devices.

With additional reference to FIGS. 7, 8 and 9, illustrated are logical operations to implement exemplary methods of the invention, e.g., connection and communications function 42 with regard to a WLAN 14. The exemplary method may be carried out by executing an embodiment of the connection and communication function 42, for example. Thus, the flow charts of FIGS. 7, 8 and 9 may be thought of as depicting steps of a method carried out by the electronic device 40. Although FIGS. 7, 8 and 9 show a specific order of executing functional logic blocks, the order of executing the blocks may be changed relative to the order shown. Also, two or more blocks shown in succession may be executed concurrently or with partial concurrence. Certain blocks also may be omitted. In addition, any number of functions, logical operations, commands, state variables, semaphores or messages may be added to the logical flow for purposes of enhanced utility, accounting, performance, measurement, troubleshooting, and the like. It is understood that all such variations are within the scope of the present invention.

Exemplary logical flow (flow chart) for the visiting mobile phone 10 is shown it 100 in FIG. 7. The connection and communications function 42 may begin in block 102 where the visiting mobile phone 10 is turned on and able to operate to carry out the following steps. At block 104 an inquiry is made whether the user of the visiting mobile phone 10 desires to connect to the WLAN 14. If not, then a loop 106 is followed. If yes, then at block 108 a message, e.g., a text message, such as an SMS (short message system) message, is sent to the home mobile phone 11. It is understood that the home mobile phone 11 may be a WLAN capable mobile phone that has parameters and/or other information that would enable it to access and to connect to the WLAN 14; and the home mobile phone 11 is capable of furnishing permission to the visiting mobile phone 10, including the parameters needed to access and to connect to the WLAN 14.

At block 108, for example, the person who is using the visiting mobile phone 10 may be a friend of the person who typically would be using the home mobile phone 11. I such case the user of the visiting mobile phone may select the “friend” (user of the home mobile phone) in the phone book or may manually input the phone number of the “friend” (user of the home mobile phone). An application, e.g., an extended phone book, or some other application comes up and sends an SMS message to the home mobile phone 11. This message may be sent using a predetermined port, e.g., one that is used for SMS messages, one that provides an indication that the user of the visiting mobile phone is a trusted user, etc.

A message then is displayed on the home mobile phone 11, as will be described below with respect to FIG. 8, to indicate that a friend who is operating the visiting mobile phone 10 is asking for permission to access and to connect to the WLAN 14 (see block 108a in FIG. 8). This message is displayed by an application that is downloaded if it is not already available.

At block 110 an inquiry is made to determine whether permission to access and to connect to the WLAN 14 has been received from the home mobile phone 11. If permission has not been granted, then a loop 106a, 106 is followed back to the input of block 104. If access is allowed, the application in the home mobile phone 10 sends an indication of the permission being granted. Such permission may be obtained from the home mobile phone in various ways. For example, the application in the home mobile phone that responds to the SMS form the visiting mobile phone may retrieve the parameters from memory, for example, of the home mobile phone and display those parameters to the user of the home mobile phone, who then may manually enter the parameters in a responding message that is sent back to the friend, who is using the visiting mobile phone. The user of the visiting mobile phone then may load the parameters manually into the visiting mobile phone at block 112.

At block 114 the visiting mobile phone 10 connects to the WLAN 14.

Turning to FIG. 8, exemplary logical flow (flow chart) 120 for the home mobile phone 11 is shown. At block 122 the home mobile phone 11 is turned on or is operated or adjusted to be responsive to requests from a visiting mobile phone 10 for permission to access and to connect to the WLAN 14.

At block 108a an inquiry is made whether permission had been requested. If not, then loop 124 is followed. If permission has been requested, then at block 126 an inquiry is made whether permission is to be granted. If permission is not granted, then loop 124a and 124 is followed to block 108a. At block 128, a refusal message may be sent to the visiting mobile phone 10 that had requested permission.

As was mentioned above, if the user of the visiting mobile phone 10 is a friend, is trusted, etc., then permission may be sent from the home mobile phone 11. However, if the user of the visiting mobile phone 10 is unknown to the user of the home mobile phone 11, then permission may be denied. If desired, the granting of permission may be automatic if the home mobile phone 11 already had designated the visiting mobile phone 10 as a friend or as trusted, etc., e.g., approved listing as was mentioned above. If desired, the denying of permission may be automatic, if the visiting mobile phone 10 is not in the home mobile phone contacts list or phone book, if the visiting mobile phone is not designated in such a contacts list or phone book as a friend or as trusted, or if the visiting mobile phone is designated on a disapproved list in the home mobile phone. These are just examples of operation to grant and/or to deny permission. If desired categories, such as friends, can be used to identify approved visiting mobile phones 10 that would receive an automatic response from the home mobile phone 11 to access and to connect to the WLAN 14. The approved list may be manually entered in the home mobile phone, e.g., in the phone book or contacts list thereof. Similarly, a disapproved list can be entered to identify visiting mobile phones that are to be ignored, not granted permission, or at least not automatically granted permission. As another alternative, the home mobile phone 11 may be set up to ignore all requests for permission that are not in its phone book or contacts list.

Various techniques have been used in the past to identify trusted communication between mobile phones or between other mobile wireless electronic devices. Such trusted communication features may be used in the present invention to identify that the visiting mobile phone 10 can be trusted by the home mobile phone 11, and, therefore, permission would be granted, e.g., as was described above.

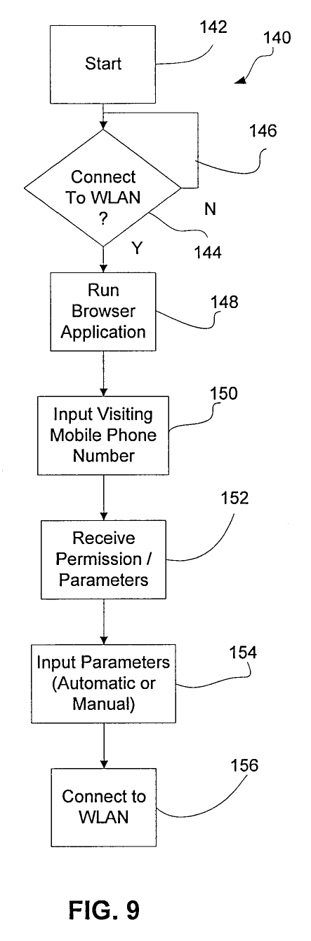

Turning, now, to FIG. 9, exemplary logical flow (flow chart) 140 for a computer application described above, e.g., in which it is desired for the computer 20 to access and to connect to the WLAN 14, is illustrated. For example, in this example and embodiment, the computer 20 obtains from the visiting mobile phone 10 permission and parameters to access and to connect to the WLAN 14. Initially the above steps of described with respect to the flow charts 100 and 120 would be carried out so that the visiting mobile phone 11 has access and, thus, the necessary parameters to obtain wireless access to and connection to the WLAN 14.

At block 142 the flow chart or routine 140 starts, e.g., the computer 20 is turned on and/or is configured to try to obtain wireless access to and to connect to the WLAN 14. At block 144 an inquiry is made whether the user of the computer 20, for example, desires to obtain wireless access to the WLAN 14. If not, then loop 146 is followed. If yes, then at block 148 a browser application is run by the computer 20. The browser application is of the type that permits the computer 20 to dial a telephone number and to connect with the dialed telephone number. At block 150 the user of the computer 20 inputs the visiting mobile phone 10 telephone number so that the computer will connect with the visiting mobile phone. At block 152 after the computer has connected with the visiting mobile phone 10, the computer may obtain the permission and parameters from the visiting mobile phone that are necessary to access and to connect to the WLAN 14. At block 154 those parameters are input automatically or manually into the computer, e.g., automatically by a suitable application in the computer that places the parameters in the appropriate locations in memory, etc., or manually by the user operating the keyboard, touch sensitive display, etc. associated with the computer to place the parameters in the appropriate locations in memory.

At block 156 the computer 20 is connected to the WLAN 14.

It will be appreciated that with the computer 20 or with the visiting mobile phone 10 accessing and connected to the WLAN 14, communication may be carried out via the WLAN 14, e.g., with other devices that are connected to the WLAN 14 and/or with other devices that are connected to the network 15. The communication may take many different forms, e.g., email, sending and/or receiving of data, video, photographs, control signals, or for any other purpose.

It will be appreciated that reference to “parameters” herein may mean numerical values, code words, keys, etc., as is known to persons who have ordinary skill in the art.

The above logic diagrams 100, 120, 140 are exemplary. The mobile phones 10, 11, 40 and the computer 20 with the features described herein may be operated in many different ways to obtain the functions and advantages described herein.

It will be appreciated that portions of the present invention can be implemented in hardware, software, firmware, or a combination thereof. In the described embodiment(s), a number of the steps or methods may be implemented in software or firmware that is stored in a memory and that is executed by a suitable instruction execution system. If implemented in hardware, for example, as in an alternative embodiment, implementation may be with any or a combination of the following technologies, which are all well known in the art: discrete logic circuit(s) having logic gates for implementing logic functions upon data signals, application specific integrated circuit(s) (ASIC) having appropriate combinational logic gates, programmable gate array(s) (PGA), field programmable gate array(s) (FPGA), etc.

Any process or method descriptions or blocks in flow charts may be understood as representing modules, segments, or portions of code which include one or more executable instructions for implementing specific logical functions or steps in the process, and alternate implementations are included within the scope of the preferred embodiment of the present invention in which functions may be executed out of order from that shown or discussed, including substantially concurrently or in reverse order, depending on the functionality involved, as would be understood by those reasonably skilled in the art of the present invention.

The logic and/or steps represented in the flow diagrams of the drawings, which, for example, may be considered an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

The above description and accompanying drawings depict the various features of the invention. It will be appreciated that the appropriate computer code could be prepared by a person who has ordinary skill in the art to carry out the various steps and procedures described above and illustrated in the drawings. It also will be appreciated that the various terminals, computers, servers, networks and the like described above may be virtually any type and that the computer code may be prepared to carry out the invention using such apparatus in accordance with the disclosure hereof.

Specific embodiments of an invention are disclosed herein. One of ordinary skill in the art will readily recognize that the invention may have other applications in other environments. In fact, many embodiments and implementations are possible. The following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

Although certain embodiments have been shown and described, it is understood that equivalents and modifications falling within the scope of the appended claims will occur to others who are skilled in the art upon the reading and understanding of this specification.

1. An electronic device to connect by wireless communication with a network, comprising
a control circuit configured to generate a request for permission for wireless access to a network from a wireless communication device, which is permitted access to the network,
a radio configured to transmit the request for permission and to receive an indication of permission for wireless accessing of the network, and
wherein following receipt of the permission the control circuit configures the radio to connect wirelessly with the network.

2. The electronic device of claim 1, wherein the radio is configured to transmit an SMS message to request permission.

3. The electronic device of claim 1, wherein the radio is configured to receive an SMS message granting permission.

4. The electronic device of claim 1, wherein the requested permission is for parameters to access a wireless local area network.

5. The electronic device of claim 1, wherein the requested permission is to connect wirelessly with an access point of a local area network.

6. The electronic device of claim 1, wherein the radio is configured to request permission for wireless access to a network from the wireless communication device that is configured and has permission to connect wirelessly with the network.

7. The electronic device of claim 1, wherein following receipt of the permission with parameters to access a wireless local area network, the control circuit automatically configures the radio to connect with the network.

8. The electronic device of claim 1, further comprising a display, and wherein the control circuit is configured in response to receipt of the permission to display parameters to access a wireless local area network.

9. The electronic device of claim 1, further comprising a manually operable input device to input parameters for the radio to connect wirelessly to the network.

10. The electronic device of claim 9, wherein the manual input device is at least one of keys or a touch sensitive display.

11. The electronic device of claim 1, comprising a mobile telephone.

12. A computer, comprising
a computer control circuit configured to operate the computer to access a browser,
a computer radio configured to connect with the electronic device of claim 1,
wherein the computer control circuit is configured to operate the computer radio to communicate with the electronic device to retrieve parameters for accessing the network.

13. The computer of claim 12, wherein the computer control circuit is configured to respond to the retrieved parameters to operate the computer radio to access the network.

14. The computer of claim 11, wherein the computer further comprises an input device to receive manual inputs of the parameters for accessing the network and the control circuit being configured in response to the parameters to access the network.

15. The computer control of claim 11, wherein the computer control circuit is configured to operate the computer radio automatically to use the parameters to access the wireless local area network.

16. A computer, comprising
a computer control circuit configured to operate the computer to access a browser to connect with a wireless communication device that has permission to access a wireless local area network to obtain from the wireless communication device parameters for accessing the wireless local area network,
a computer radio configured to connect with the wireless communication device under control of the computer control circuit,
wherein the computer control circuit is configured to operate the computer radio to communicate with the electronic device to retrieve parameters for accessing the network, and
wherein the computer control circuit is configured to respond to the retrieved parameters to operate the computer radio to access the wireless local area network.

17. The computer of claim 16, wherein the computer further comprises an input device to receive manual inputs of the parameters for accessing the network and the computer control circuit being configured in response to the parameters to access the network.

18. The computer of claim 16, wherein the computer control circuit is configured to operate the computer radio automatically to use the parameters to access the wireless local area network.

19. A method for generating a request for permission for wireless access to a network from a wireless communication device, which is permitted access to the network, comprises transmitting the request for permission and receiving an indication of permission for wireless accessing of the network, and following receipt of the permission the control circuit connecting wirelessly with the network.

20-23. (canceled)
